(19) United States
(12) Patent Application Publication
(10) Pub. No.: US 2024/0034675 A1
(43) Pub. Date: Feb. 1, 2024

(54) CARBONATION OF RECYCLED CONCRETE

(71) Applicant: X Development LLC, Mountain View, CA (US)

(72) Inventors: Antonio Raymond Papania-Davis, Oakland, CA (US); Ray Jr. Anthony Nagatani, San Francisco, CA (US); Shijian Jin, Cambridge, MA (US)

(21) Appl. No.: 17/874,935

(22) Filed: Jul. 27, 2022

(51) Int. Cl. C04B 18/16; C04B 20/10

(52) U.S. Cl. CPC C04B 18/167; C04B 20/1066; C04B 2111/00017

(57) ABSTRACT

Methods, systems, and apparatus, including computer programs encoded on computer storage media, for processing recycled concrete aggregate (RCA). A method includes obtaining an aqueous carbonate solution by exposing an aqueous alkaline solution to a carbon dioxide laden fluid; performing a treatment process on a first portion of RCA particles using a first set of parameters, the treatment process including exposing the first portion of RCA particles to the aqueous carbonate solution; after performing the treatment process, obtaining measurements of the first portion of RCA particles; determining, using the measurements of the first portion of RCA particles, a second set of parameters; and performing the treatment process on a second portion of RCA particles using the second set of parameters. Exposing the first portion of RCA particles to the aqueous carbonate solution includes soaking the first portion of RCA particles in the aqueous carbonate solution.

### TECHNICAL FIELD

The present specification relates to treatment systems for recycled concrete aggregate.

### BACKGROUND

Concrete is the second most consumed substance (by mass) on our planet and is responsible for seven to eight percent of global carbon dioxide emissions. Concrete's material properties are inconsistent due to the large variation in ingredient material (e.g., aggregates) and processing. This material inconsistency requires large safety margins for a given performance level and results in material overuse. Advances in concrete preparation that can optimize the use of locally available materials to maximize concrete performance while minimizing cost with both traditional and non-traditional concrete ingredients are desirable.

Projections for growth in global construction are quite robust. This growth will compound an existing problem: over six billion tons of construction and demolition waste are generated by this activity, and most of it goes to landfill. In addition to the environmental consequences stemming from overfilling of landfills, there are also economic consequences as landfill costs can be substantial in high growth markets. This represents an equally large waste of material and energy that could significantly lower the environmental and dollar cost of producing new materials for construction.

Additionally, global carbon dioxide levels may continue to rise because of this increased level of construction. However, processes for capturing and sequestering carbon can be costly, making it challenging to offset the carbon dioxide impact of construction while maintaining budget feasibility.

### SUMMARY

In general, this disclosure relates to a process and system for preparing and mixing recycled concrete to permanently sequester carbon and achieve improved concrete characteristics. In particular, systems and methods are disclosed to perform a recycled concrete aggregate (RCA) carbonation process. In general, an aqueous alkaline solution captures carbon dioxide from a carbon dioxide laden fluid such as air or flue gas, forming an aqueous carbonate solution. RCA particles are then soaked in the aqueous carbonate solution, sequestering the carbon dioxide in the RCA particles. The disclosed techniques can be used to efficiently sequester carbon into concrete, producing concrete with increased strength, reduced water adsorption, and reduced porosity.

Concrete waste has the potential for carbon dioxide uptake. Uptake rates are highly dependent on input composition (e.g., size/surface area, chemical composition) and treatment regimes. The strength and durability characteristics of older, lower-quality concrete aggregate waste can be augmented to prevent limitation of the performance. Output treated particles can be characterized in real-time or near real-time to determine whether treatment was sufficient to meet specification (e.g., compressive strength), and whether upstream treatment processes (e.g., crush, carbon dioxide uptake from aqueous carbonate solution, chemical treatment) are enabling the desired outcome.

To produce the aqueous carbonate solution, an aqueous alkaline solution can be exposed to carbon-rich gas. An example alkaline solution is potassium hydroxide, and an example carbonate solution is potassium carbonate. The alkaline solution can be exposed to gas, for example, using a bubbler. For example, the alkaline solution can be contained in a tank, and an air pump can pump air into the tank, introducing air bubbles into the alkaline solution. Carbon dioxide from the air dissolves from the air bubbles into the alkaline solution, forming the carbonate solution.

In some examples, the alkaline solution can be exposed to gas using an agitator. For example, a tank containing the alkaline solution can be exposed to the atmosphere and/or can have a layer of gas above the alkaline solution. The alkaline solution can be mechanically agitated, causing turbulence in the alkaline solution. The turbulence increases the surface area of exposure of the alkaline solution to the gas, causing the alkaline solution to absorb carbon dioxide from the gas. Other methods of exposing the alkaline solution to gas can be implemented. For example, a cross-flow or counter-flow cooling tower system can be implemented, in which air flows across falling droplets of aqueous solution.

Crushed RCA particles are treated using the carbonate solution. In some examples, the RCA particles can be soaked, sprayed, or showered in the carbonate solution. The RCA particles can be soaked in the carbonate solution at conditions according to a set of parameters. The conditions can include, for example, a time of soaking, a temperature, a pressure, and a volume ratio between RCA particles and carbonate solution. In some examples, the RCA particles can be soaked in the carbonate solution at atmospheric temperature and pressure conditions.

In some implementations, the exposure of the alkaline solution to carbon rich gas, and the exposure of the RCA particles to the carbonate solution, can occur in the same vessel. For example, the alkaline solution can be contained in a tank, and air can be introduced to the alkaline solution in the tank during a first time period, producing the carbonate solution. A batch of RCA particles can then be inserted into the tank and soaked in the carbonate solution during a second time period. In some examples, the first time period and the second time period can be the same or can overlap.

A batch of RCA particles can be, for example, hundreds or thousands of gallons of RCA particles. In some examples, the batch of RCA particles can be inserted into the tank and removed from the tank using a permeable basket. For example, the RCA particles can be loaded into a permeable basket and submerged or dunked in the tank. After soaking in the carbonate solution, the RCA particles can be removed from the tank, and the process can repeat. In some examples, a continuous stream of RCA particles can be inserted and removed from the carbonate solution. For example, the RCA particles can be transported through a tank containing the carbonate solution on a conveyor.

In some implementations, the exposure of the alkaline solution to carbon rich gas, and the exposure of the RCA particles to the carbonate solution, can occur in different vessels. For example, the alkaline solution can be placed in a first tank, and gas can be introduced to the alkaline solution in the first tank, producing the carbonate solution. The carbonate solution can then be transported to a second vessel, where the RCA particles are exposed to the carbonate solution. The carbonate solution releases carbon to the RCA particles, producing the alkaline solution. The alkaline solution can then be returned to the first tank to repeat the process.

Measurements can be obtained of the treated RCA particles, and parameters of the treatment process can be adjusted based on the measurements. Example measurements can include, but are not limited to, pH, conductivity, tensile strength, and porosity. Parameters can include, but are not limited to, RCA crushing conditions, RCA treatment recipes, and concrete ingredient recipes.

Advantages of the disclosed techniques include the following. The disclosed techniques can be used to efficiently, permanently sequester carbon into concrete using low levels of energy consumption, while mitigating carbon emissions and potentially achieving negative carbon emissions. In some implementations, the disclosed systems can be transportable and/or portable. For example, a vessel for soaking RCA particles in carbonate solution can be sized to fit on a truck for transport to a site such as a quarry or construction site. Using the disclosed systems and techniques, the strength, durability, and corrosion resistance characteristics of older, lower-quality concrete aggregate waste can be augmented to improve material performance. Furthermore, output treated particles can be characterized in real-time to determine whether upstream treatment processes (e.g., crush, carbon dioxide uptake, chemical treatment) is sufficient to produce concrete meeting specifications (e.g., compressive strength).

In general, innovative aspects of the subject matter described in this specification can be embodied in a method of treating recycled concrete aggregate (RCA), the method including: obtaining an aqueous carbonate solution by exposing an aqueous alkaline solution to a carbon dioxide laden fluid; performing a treatment process on a first portion of RCA particles using a first set of parameters, the treatment process including exposing the first portion of RCA particles to the aqueous carbonate solution; after performing the treatment process, obtaining measurements of the first portion of RCA particles; determining, using the measurements of the first portion of RCA particles, a second set of parameters; and performing the treatment process on a second portion of RCA particles using the second set of parameters.

These and other embodiments may each optionally include one or more of the following features, alone or in combination. In some implementations, exposing the first portion of RCA particles to the aqueous carbonate solution includes soaking the first portion of RCA particles in the aqueous carbonate solution.

In some implementations, exposing the aqueous alkaline solution to the carbon dioxide laden fluid includes introducing ambient air to the aqueous alkaline solution.

In some implementations, exposing the aqueous alkaline solution to the carbon dioxide laden fluid includes introducing flue gas to the aqueous alkaline solution.

In some implementations, obtaining the aqueous carbonate solution by exposing the aqueous alkaline solution to the carbon dioxide laden fluid includes agitating the aqueous alkaline solution in the presence of the carbon dioxide laden fluid.

In some implementations, obtaining the aqueous carbonate solution by exposing the aqueous alkaline solution to the carbon dioxide laden fluid includes introducing bubbles of the carbon dioxide laden fluid into the aqueous alkaline solution.

In some implementations, the aqueous alkaline solution includes potassium hydroxide, and the aqueous carbonate solution includes potassium carbonate.

In some implementations, the method includes determining, using the measurements of the first portion of RCA particles, a set of chemical modification parameters; and performing chemical modification of the first portion of RCA particles using the set of chemical modification parameters.

In some implementations, performing the chemical modification of the first portion of RCA particles includes chemically treating the first portion of RCA particles with one or more chemical additives.

In some implementations, the first set of parameters and the second set of parameters each include at least one of: a pressure at which the treatment process is performed; a temperature at which the treatment process is performed; a volume ratio between RCA particles and aqueous carbonate solution; a pH of the aqueous carbonate solution; a conductivity of the aqueous carbonate solution; or a time of exposure of the RCA particles to the aqueous carbonate solution.

In some implementations, the measurements of the first portion of RCA particles include at least one of pH, conductivity, tensile strength, sphericity, size, or porosity.

In general, innovative aspects of the subject matter described in this specification can be embodied in a system for treating recycled concrete aggregate (RCA), including: a contactor configured to facilitate capture of carbon dioxide from a carbon dioxide laden fluid by an aqueous alkaline solution to produce an aqueous carbonate solution; a treatment tank in fluid communication with the contactor configured to perform a treatment process on RCA particles including exposing the RCA particles to the aqueous carbonate solution; a plurality of sensors configured to generate sensor data indicating measurements of the RCA particles; and a control system configured to perform operations including: obtaining sensor data indicating measurements of a first portion of RCA particles after the treatment process is performed on the first portion of RCA particles using a first set of parameters; and determining, using the sensor data, a second set of parameters for performing the treatment process on a second portion of RCA particles.

These and other embodiments may each optionally include one or more of the following features, alone or in combination. In some implementations, the contactor and the treatment tank are contained within the same vessel.

In some implementations, the contactor is contained within a first vessel; and the treatment tank is contained within a second vessel.

In some implementations, the system includes a circulation system for transporting the aqueous alkaline solution and the aqueous carbonate solution between the first vessel and the second vessel.

In some implementations, performing the treatment process includes soaking the RCA particles in the aqueous carbonate solution.

In some implementations, the carbon dioxide laden fluid includes ambient air or flue gas.

In some implementations, facilitating capture of carbon dioxide from the carbon dioxide laden fluid by the aqueous alkaline solution to produce the aqueous carbonate solution includes agitating the aqueous alkaline solution in the presence of the carbon dioxide laden fluid.

In some implementations, facilitating capture of carbon dioxide from the carbon dioxide laden fluid by the aqueous alkaline solution to produce the aqueous carbonate solution includes introducing bubbles of the carbon dioxide laden fluid into the aqueous alkaline solution.

In some implementations, the aqueous alkaline solution includes potassium hydroxide, and the aqueous carbonate solution includes potassium carbonate.

Other embodiments include corresponding computer systems, apparatus, computer program products, and computer programs recorded on one or more computer storage devices, each configured to perform the actions of the methods. A system of one or more computers can be configured to perform particular operations or actions by virtue of having software, firmware, hardware, or a combination of them installed on the system that in operation causes or cause the system to perform the actions. One or more computer programs can be configured to perform particular operations or actions by virtue of including instructions that, when executed by data processing apparatus, cause the apparatus to perform the actions.

The details of one or more embodiments of the subject matter described in this specification are set forth in the accompanying drawings and the description below. Other features, aspects, and advantages of the subject matter will become apparent from the description, the drawings, and the claims.

### BRIEF DESCRIPTION OF THE DRAWINGS

FIG. 1 depicts an exemplary recycled concrete treatment system.

FIG. 2 depicts an exemplary carbonation system including a separate contactor and treatment tank.

FIG. 3 depicts an exemplary carbonation system including a combined contactor and treatment tank.

FIG. 4 depicts a flow diagram that illustrates an example process for operating the recycled concrete treatment system of FIG. 1.

FIG. 5 depicts a schematic diagram of a computer system that may be applied to any of the computer-implemented methods and other techniques described herein.

Like reference numbers and designations in the various drawings indicate like elements.

### DETAILED DESCRIPTION

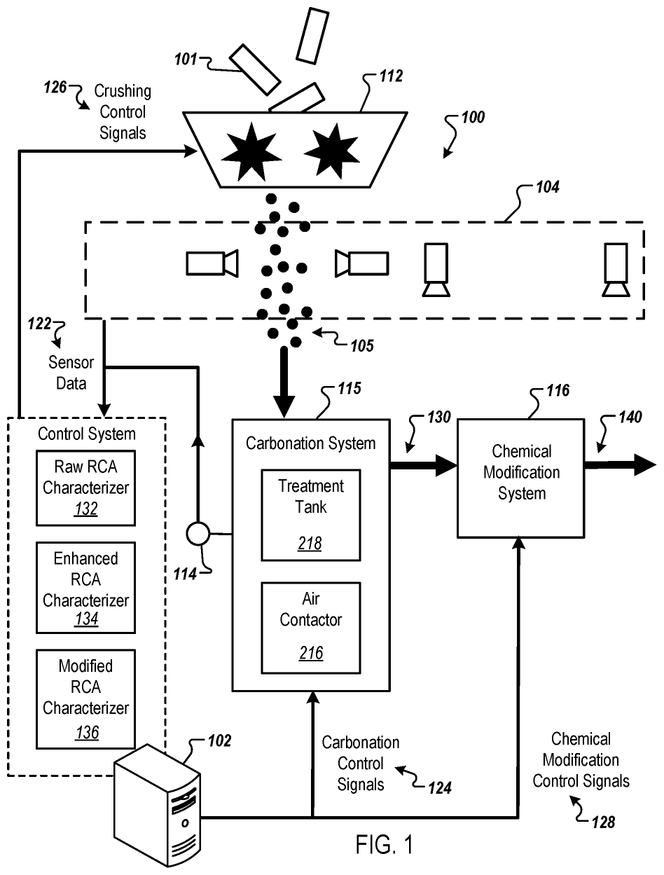

FIG. 1 depicts an exemplary recycled concrete treatment system 100. In operation, the recycled concrete treatment system 100 crushes concrete waste 101 in a crusher 112. The crusher 112 produces recycled concrete aggregate (RCA) particles (“raw RCA particles 105”). Recycled concrete treatment system 100 can enhance and upgrade the raw RCA particles 105 to achieve desired structural properties by embedding the raw RCA particles 105 with carbon dioxide and additives.

Crushed raw RCA particles 105 can be conveyed from the crusher 112 to a carbonation system 115. For example, the raw RCA particles 105 can be conveyed by a series of conveyors and augers. A purpose of the carbonation process is to store carbon dioxide in the particles in order to improve particle properties. Carbonation decreases the water absorption coefficient by filling pores due to the formation of calcium carbonates. Thus, carbonation leads to the formation of calcium carbonates and to a decrease in total porosity. The capillary porosity is decreased due to clogging of the pores. In addition, carbonation increases the microporosity of particles as a result of decalcification and mercury intrusion.

In some examples the recycled concrete treatment system 100 processes large batches of raw RCA particles 105. In some examples, the large batches are processed through components of the system 100 in smaller batches, or portions, of particles. In some examples, RCA particles of a large batch are fed continuously or near continuously through the components of the system 100.

The carbonation system 115 produces enhanced particles 130. Enhanced particles 130 can be particles that have undergone the carbonation process. A post processing characterization stage can be performed using the same reactivity estimation and other optically determined physical characteristics to provide an accurate estimation of the enhanced particles' compression strength, porosity, uniformity, and other physical characteristics. This measure can allow for quality control by providing insights into material strength, water absorption, and flowability.

In some implementations, the carbonation system 115 outputs enhanced RCA particles 130 to a chemical modification system 116. The chemical modification system 116 performs chemical treatment processes on the enhanced RCA particles 130. For example, the chemical treatment processes can include using a chemical modification vessel to add silicate to the enhanced RCA particles 130. The chemical modification system 116 outputs modified RCA particles 140.

The control system 102 can adjust parameters of the chemical modification system 116 using chemical modification control signals 128. The parameters can be adjusted based on sensor data 122 generated by the sensors 104. For example, the control system 102 can receive sensor data 122 indicating characteristics of the enhanced RCA particles 130 and the modified RCA particles 140. Based on analyzing the sensor data, the control system 102 can adjust the chemical modification control signals 128 in order to change conditions in the chemical modification system 116.

The control system 102 can adjust upstream processing parameters, downstream processing parameters, or both, based on the sensor data 122. For example, the enhanced RCA characterizer 134 can determine characterizations of a first portion of enhanced RCA particles 130 using the sensor data 122. The first portion of enhanced RCA particles 130 can be, for example, a volume of enhanced RCA particles that have been processed by the carbonation system 115. The first portion of enhanced RCA particles 130 can be a first portion of a larger batch of particles.

Based on the characterizations of the first portion of enhanced RCA particles 130, the control system 102 can modify the carbonation control signals 124 to adjust parameters of the carbonation system 115 for a second portion of particles that enters the carbonation system 115 after the first portion of particles. Thus, the characterizations can be used as feedback to adjust upstream processes.

Based on the characterizations of the first portion of the enhanced RCA particles 130, the control system 102 can modify the chemical modification control signals 120 to adjust parameters of the chemical modification system 116 for processing the first portion of the enhanced RCA particles 130. Thus, the characterizations can be used to adjust downstream processes.

Based on the characterizations of the first portion of enhanced RCA particles 130, the control system 102 can determine to reprocess the first portion of enhanced RCA particles 130 through the carbonation system 115. For example, the control system 102 can determine whether the characterizations of the first portion of enhanced RCA particles 130 satisfy criteria for enhanced RCA particles. In response to determining that the characterizations of the first portion of enhanced RCA particles 130 do not satisfy the criteria, the control system 102 can determine to return some or all of the first portion of enhanced RCA particles 130 to the carbonation system 115 to undergo additional carbonation treatment. The RCA particles that are returned to the carbonation system 115 for a second round of carbonation treatment can be treated using the same parameters as the first round of treatment, or using adjusted parameters determined by the control system 102.

Though FIG. 1 shows the carbonation system 115 and the chemical modification system 116 as being two separate systems, in some implementations, chemical treatment can be performed by the carbonation system 115. For example, the raw RCA particles 105 may undergo carbonation and chemical treatment in the same vessel. The carbonate solution may include additives for chemically treating the raw RCA particles 105. In some implementations, additional chemical treatment might not be needed after the carbonation process, and the enhanced RCA particles 130 exiting the carbonation system 115 can be added directly to a concrete mixture.

In some implementations, the carbonation system 115 outputs modified RCA particles 140 to a concrete batching system (not shown). The concrete batching system mixes the modified RCA particles 140 to form a concrete mixture. The concrete mixture can then be used for construction.

Recycled concrete treatment system 100 includes the control system 102. The control system 102 includes a computing system that is configured to control various aspects of the recycled concrete treatment process, including processes for carbonation of RCA particles. For example, the computing system can store and execute one or more computer instruction sets to control the execution of aspects of the recycled concrete preparation processes described herein. The computing system can include a system of one or more computing devices. The computing system can include a system of one more servers. For example, a first server can be configured to receive and process data from sensors, e.g., sensors 104, 114. Another server can be configured to issue control signals, e.g., control signals 124, 126, 128 based on analysis results from the first server.

In some implementations, the computing system can be operated or controlled from a user computing device. The user computing device can be, e.g., desktop computer, laptop computer, tablet computer, or other portable or stationary computing device.

The control system 102 receives sensor data 122 from sensors 104. The sensors 104 are arranged to obtain measurement data of raw RCA particles 105, enhanced RCA particles 130, modified RCA particles 140, a concrete mixture, or any combination of these. In some implementations, sensors such as optical sensors can be arranged in an array along a conveyor or a chute used to convey the raw RCA particles 105 to the carbonation system 115 and to convey the enhanced RCA particles 130 to the chemical modification system 116. The sensors 104 can transmit images of the particles to the control system 102, which can use algorithms such as image processing algorithms to identify particle shapes and sizes. Algorithms can include those described in U.S. patent application Ser. No. 17/159,496, the contents of which are hereby incorporated by reference.

The sensors 104 include various different sensors configured to measure various characteristics of concrete particles. For example, the sensors 104 can include, but are not limited to, optical sensors (e.g., visible light cameras, infra-red cameras, near IR (NIR) sensors, dynamic optical microscopy sensors) and mechanical sensors (e.g., sieves, sedigraphs, impact hammer, electrodynamic vibrator), and spectrometers. In some examples, diffuse reflectance spectroscopy can be used across the visible, near- and shortwave-infrared spectral regions (400 nm to 2500 nm) as a tool to assess the strength of particles.

In some implementations, the control system 102 receives sensor data 122 from carbonation system sensors 114. The carbonation system sensors 114 can include, for example, pH sensors and conductivity sensors. The control system 102 can determine a dissolved inorganic carbon (DIC) content using the pH and conductivity measurements. The carbonation system sensors 114 can include, e.g., inductively coupled plasma mass spectrometers, DIC analyzers, thermocouples, or any combination of these.

The control system 102 can control the operations of one or more ingredient metering systems based on analyses of data obtained from the sensors 104 and carbonation system sensors 114. The sensor data 122 indicates measurements of the raw RCA particles 105, of enhanced RCA particles 130, and of the modified RCA particles 140. The control system 102 can use the sensor data 122 to determine characteristics of the raw RCA particles 105, the enhanced RCA particles 130, and the modified RCA particles 140.

In some implementations, the control system 102 can include a set of operations modules for controlling different aspects of an RCA treatment process. The operation modules can be provided as one or more computer executable software modules, hardware modules, or a combination thereof. For example, one or more of the operation modules can be implemented as blocks of software code with instructions that cause one or more processors of the computing system to execute operations described herein. In addition or alternatively, one or more of the operations modules can be implemented in electronic circuitry such as, e.g., programmable logic circuits, field programmable logic arrays (FPGA), or application specific integrated circuits (ASIC). The operation modules can include a raw RCA characterizer 132, an enhanced RCA characterizer 134, and a modified RCA characterizer 136.

The control system 102 includes a raw RCA characterizer 132 for characterizing the raw RCA particles 105, and an enhanced RCA characterizer 134 for characterizing the enhanced RCA particles 130. The raw RCA characterizer 132 and the enhanced RCA characterizer 134 can characterize RCA particles by analyzing sensor data 122 from the sensors 104. The raw RCA particles 105 and enhanced RCA particles 130 can be characterized using, for example, SEM, FTIR, XRF, and TGA for micro-hardness, porosity and composition. Particle characteristics can include, but are not limited to, particle sizes, shapes, surface areas, sphericity, porosity, density, strength, and particle size distribution.

The particle analysis can be used to optimize the additive reactant and process parameters. For example, the control system 102 can send control signals 124 to control an amount of carbon dioxide provided to the raw RCA particles 105 by the carbonation system 115. By adaptively maximizing the degree to which additive reactions accrue, carbon uptake by the particles can be increased. Additionally, compression strength of heterogeneous particle mixtures can be enhanced.

The enhanced RCA particles 130 undergo chemical treatment in the chemical modification system 116. The sensors 104 can include sensors that measure conditions within a chemical treatment vessel of the chemical modification system 116. For example, the sensors 104 can include pH sensors, temperature sensors, sensors to detect presence of various chemicals, ionic strength sensors, or any combination of these.

The sensors 104 can also include sensors that measure various attributes of the modified RCA particles 140 output from the chemical modification system 116. For example, the sensors 104 can include spectrometers, cameras, fluorescence sensors, or any combination of these.

Sensor data 122 indicating the measurements of the chemical modification system conditions, the modified RCA particle properties, or both, are provided to the control system 102. The control system 102 includes a modified RCA particle characterizer 136. The modified RCA particle characterizer 136 can estimate or compute properties of the modified RCA particles in real-time or near-real time using the sensor data 122. The modified RCA particles 140 can be mixed into a concrete mixture by a concrete batching system.

The sensors 104 can include, but are not limited to, viscosity sensors, rheometers, temperature sensors, moisture sensors, ultrasonic sensors (e.g., ultrasonic pulse velocity sensors), electrical property sensors (e.g., electrodes, electrical resistance probes), electromagnetic sensors (e.g., short-pulse radar), or other sensors (e.g., geophone, accelerometer). The properties of the RCA particles can be evaluated through tensile tests, X-ray diffraction, micro-hardness measurements, and porosity tests. The sensors 104 can include, but are not limited to, hydrophobicity, moisture content, XRD spectra, XRF spectra, static yield stress, acoustic impedance, p-wave speed, density, resonance frequency, nuclear magnetic resonance (NMR), dielectric constant, electric resistivity, polarization potential, and capacitance. For example, viscosity, moisture, and temperature sensors can be used to measure rheologic properties of the concrete mixture such as changes in the viscosity of the mixture over time and at different moisture content levels and temperatures.

Measurements and characterizations of the raw RCA particles 105, the enhanced RCA particles 130, and the modified RCA particles 140 can be used to determine updated parameters for the RCA treatment processes. For example, the control system can generate updated parameters for aqueous treatment, crushing conditions, cement recipes, or any combination of these. The control system 102 can use the measurements and characterizations to determine whether to adjust parameters of the carbonation system 115, the chemical modification system 116, the concrete batching system, or any of these to obtain desired RCA and concrete properties.

The control system 102 can adjust operating parameters of the crusher 112 based on sensor data 122 using crushing control signals 126. The control system 102 can use crushing control signals 126 to adjust one or more parameters of the crushing process performed by the crusher 112, such as a size of raw RCA particles 105 crushed by the crusher 112. The control signals 126 can direct the crusher 112 to crush the concrete waste 101 to particular sizes and/or geometries. In some examples, crushing control signals 126 from the control system 102 can cause the crusher 112 to increase or decrease sizes of the raw RCA particles 105.

The control system 102 can use carbonation control signals 124 to control parameters of the carbonation process performed by the carbonation system 115. The carbonation system 115 performs a process for carbonation of the raw RCA particles 105. Based on the size, surface area, shape, porosity, water absorption rate, and calcium hydroxide content of the raw RCA particles 105, the control system 102 can adjust parameters of the carbonation system 115 using the carbonation control signals 124. The parameters can include, for example, temperature, aqueous solution volume, and carbon dioxide concentration.

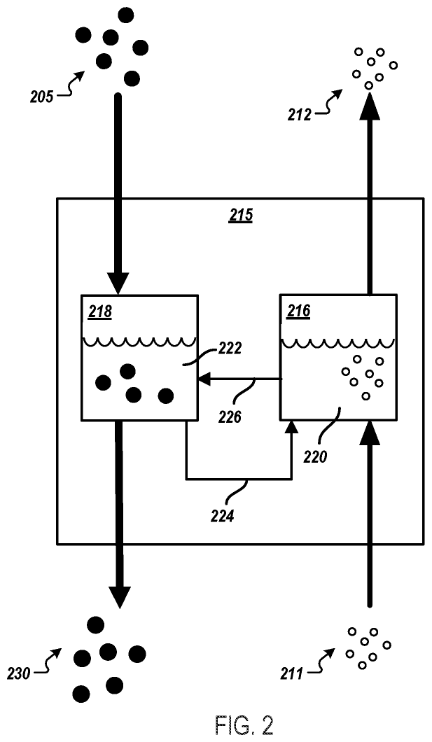

FIG. 2 depicts an example carbonation system 215. In general, the carbonation system 215 treats the raw RCA particles 205 with an aqueous carbonate solution. An aqueous solution is a solution in which the solvent is water. The aqueous carbonate solution is obtained through carbon capture by an aqueous alkaline solution that occurs when the aqueous alkaline solution is exposed to a carbon dioxide laden fluid, such as ambient air or flue gas. The carbonation system 215 can treat the raw RCA particles 205, for example, with potassium carbonate (K₂CO₃) or potassium bicarbonate (KHCO₃) solutions obtained through potassium hydroxide (KOH) carbon capture. The carbonate solution may include chemical additives, such as silicate.

In some implementations, the exposure of the alkaline solution to carbon rich fluid, and the exposure of the raw RCA particles 205 to the carbonate solution, can occur in different vessels. For example, referring to FIG. 2, the carbonation system 215 includes contactor 216 and treatment tank 218, implemented as separate vessels. The contactor 216 and the treatment tank 218 are in fluid communication through a series of fluid communication channels, e.g., piping systems. A first fluid communication channel 224 is configured to transport fluid from the treatment tank 218 to the contactor 216. A second fluid communication channel 226 is configured to transport fluid from the contactor 216 to the treatment tank. For example, the alkaline solution 220 enters the contactor 216 through the first fluid communication channel 224 and exits the contactor 216 through second fluid communication channel 226. The carbonate solution 222 enters the treatment tank 218 through the second fluid communication channel 226 and exits the treatment tank 218 through the first fluid communication channel 224.

The contactor 216 generally operates to pass carbon rich air 211 (which includes gaseous carbon dioxide) over or through the aqueous alkaline solution 220. The alkaline solution acts as an aqueous sorbent for absorbing carbon dioxide from the air 211. The carbon rich air 211 is exposed to the alkaline solution 220 in the contactor 216, producing the carbonate solution 222 through direct air capture. After releasing carbon dioxide in the contactor 216, carbon lean air 212 exits the contactor 216.

To produce the aqueous carbonate solution, an aqueous alkaline solution can be exposed to carbon rich gas, e.g., ambient air. An example alkaline solution is aqueous potassium hydroxide, and an example carbonate solution is aqueous potassium carbonate. The alkaline solution can have a concentration of approximately 1 molar or greater (e.g., 2 molar or greater, 4 molar or greater, 8 molar or greater). For example, the alkaline solution may have a concentration of 6 molar potassium hydroxide.

An example reaction within the contactor 216 is provided in Equation 1.

CO₂+2KOH→H₂O+K₂CO₃ Equation 1

When the alkaline solution is exposed to carbon-rich gas, the reaction shown in Equation 1 will occur, converting KOH to K₂CO₃ over time. A percentage of the KOH in the alkaline solution will be converted to K₂CO₃. The percentage of KOH converted to K₂CO₃ may be, for example twenty percent or greater (e.g., thirty percent or greater, forty percent or greater, fifty percent or greater).

In some examples, within the contactor 216, the alkaline solution can be exposed to air 211 using a bubbler. For example, the alkaline solution can be contained in a tank, and an air pump can pump air 211 into the tank, introducing air bubbles into the alkaline solution. Carbon dioxide from the air 211 dissolves from the air bubbles into the alkaline solution, forming the carbonate solution.

In some examples, within the contactor 216, the alkaline solution can be exposed to air 211 using an agitator. For example, a tank containing the alkaline solution can be exposed to the atmosphere and/or can have a layer of air 211 above the alkaline solution. The alkaline solution can be mechanically agitated or boggled, causing turbulence in the alkaline solution. The turbulence can increase the surface area of exposure of the alkaline solution to the air 211, causing the alkaline solution to absorb carbon dioxide from the air 211. The agitation can be performed uniformly or semi-uniformly in order to produce a homogeneous carbonate solution.

The contactor 216 can use any appropriate means for exposing the alkaline solution to the air 211. For example, the contactor 216 can include an air injector, a mister, a pulse flow reactor, a baffled pulse flow reactor, or any combination of these.

In some examples, the alkaline solution is introduced to the contactor 216 in portions or batches. For example, a first volume of alkaline solution can be introduced to the contactor 216 and exposed to the air 211 for a specified time duration, e.g., a specified number of minutes or hours. The amount of time of exposure between the alkaline solution and the air 211 can be determined based on various factors. In some examples, the amount of time of exposure between the alkaline solution and the air 211 can be determined by the control system 102, and can be controlled by the control system 102 using the carbonation control signals 124. The factors can include, for example, a volume of alkaline solution, a volumetric flow rate of the air 211, a carbon dioxide concentration of the air 211, a desired carbon concentration of the treatment solution, or any of these.

After exposure to air, the first volume of the treatment solution can be removed from the contactor 216. In some examples, the alkaline solution continuously flows into the contactor 216, and the carbonate solution continuously flows out of the contactor 216. For example, the alkaline solution can be pumped into the contactor 216, and the carbonate solution can be pumped out of the contactor 216, at the same or approximately the same volumetric flow rate.

The carbonate solution 222 exits the contactor 216 and is transported to the treatment tank 218. The treatment tank 218 generally operates to remove carbon dioxide from the aqueous carbonate solution 222 and enhance raw RCA particles 205 with the carbon dioxide to produce enhanced RCA particles 230. In the treatment tank 218, the raw RCA particles 205 are exposed to the carbonate solution 222. The carbonate solution 222 releases carbon dioxide to the raw RCA particles 205, causing the carbonate solution 222 to revert to an alkaline solution 220. The alkaline solution 220 can then be returned to the contactor 216 to repeat the carbonation process.

The aqueous carbonate solution 222 releases the carbon dioxide, forming an alkaline solution 220. The alkaline solution can then be reused to capture more carbon dioxide in the contactor 216 in a continual cycle. The aqueous solutions (e.g., the alkaline solution and carbonate solution) can be transported between the contactor 216 and the treatment tank 218 in a circulation system. The circulation system can include, for example, piping connecting the contactor 216 to the treatment tank 218. The circulation system can include one or more pumps for driving the aqueous solutions between the contactor 216 and the treatment tank 218 and for controlling the flow rate of the aqueous solutions in the piping. In some examples, the aqueous solutions flow in a closed loop between the contactor 216 and the treatment tank 218.

In the treatment tank 218, the raw RCA particles 205 are treated using the carbonate solution. In some examples, the RCA particles can be soaked, bathed, or showered in the carbonate solution. Carbon dioxide is released from the carbonate solution 222. The separated carbon dioxide is embedded in the raw RCA particles 205 through absorption to form the carbon dioxide enhanced RCA particles 230.

In some examples, the raw RCA particles 205 are treated with K₂CO₃ or KHCO₃ solutions, which are obtained through KOH carbon capture. In some examples, chemical additives can be added to accelerate and modify the reaction. A reactive species at the surface of the raw RCA particles 205 is calcium hydroxide (Ca(OH)₂). When the raw RCA particles 205 are soaked in K₂CO₃ or KHCO₃ solution, calcium carbonate (CaCO₃) is formed. An example reaction within the treatment tank 218 is provided in Equation 2.

K₂CO₃+Ca(OH)₂→2KOH+CaCO₃ Equation 2

When CaCO₃ is formed, pores of the RCA close and water absorptivity decreases. The DIC concentration, analogous to CO₂ capacity, in K₂CO₃ solution is higher than in carbonated water. For example, K₂CO₃ can have approximately 8.0 molar DIC while water might only contain 0.035 molar DIC. The rate of CaCO₃ formation is therefore faster and the amount forming will also be higher than in carbonated water. The reaction of K₂CO₃ and Ca(OH)₂ generates KOH. No additional compression or sequestration is needed since the CO₂ is already sequestered in RCA. Soaking RCA in K₂CO₃ or KHCO₃ solution can reduce the water absorption coefficients of the RCA by four percent or greater (e.g., five percent or greater, six percent or greater, seven percent or greater).

Treatment solutions can include any aqueous or nonaqueous carbonate, bicarbonate or carbamate solutions. For example, a carbon dioxide-saturated amine solution can be used for treating RCA particles. The reactive species in the RCA is not limited to Ca(OH)₂. The reactive species can be any metal (e.g., Al, Mg, Fe) or can be an oxide, hydroxide, or silicate. The concentration of the treatment solution can be 0.5 molar DIC or greater (e.g., 1.0 molar DIC or greater, 5.0 molar DIC or greater, 10.0 molar DIC or greater)

The RCA particles can be soaked in the carbonate solution at conditions according to a set of parameters. The conditions can include, for example, a time of soaking, a temperature, a pressure, and a volume ratio between RCA particles and carbonate solution. In some examples, the RCA particles can be soaked in the carbonate solution at atmospheric temperature and pressure conditions. The time of soaking can be several hours. For example, the time of soaking can be one hour or greater (e.g., two hours or greater, four hours or greater, six hours or greater). The parameters specifying the conditions under which the RCA particles are soaked in the carbonate solution can be determined by the control system 102, and can be controlled by the control system 102 using the carbonation control signals 124.

A batch, or portion, of raw RCA particles 105 can include hundreds or thousands of gallons of RCA particles. In some examples, a batch of RCA particles can be input to the carbonation system 115, carbonated simultaneously, and removed from the carbonation system 114. In some examples, the batch of RCA particles can be inserted into the tank and removed from the tank using a permeable basket. For example, the RCA particles can be loaded into a permeable basket and submerged or dunked in the tank. After soaking in the carbonate solution, the RCA particles can be removed from the tank, and the process can repeat. In some examples, a continuous stream of RCA particles can be input and removed from the carbonation system 115. For example, the RCA particles can be fed through a tank containing the carbonate solution on a conveyor. At a given time, a first portion of RCA particles may be exiting from the carbonation system 114 while a second portion of RCA particles is entering the carbonation system 114. In some examples, parameters of the carbonation system 115 can be adjusted during processing of raw RCA particles 105.

In an example, a first portion of enhanced RCA particles 130 exits the carbonation system 115. Sensor data is generated representing characteristics of the enhanced RCA particles 130. The control unit 102 adjusts parameters of the carbonation system 115 in real time or near-real time. Thus, a next portion of RCA particles that enters the carbonation system 115 following the first portion of RCA particles is treated by the carbonation system 115 using the adjusted parameters.

After releasing the carbon dioxide to the raw RCA particles, the carbonate solution reverts to an alkaline solution 220. The alkaline solution 220 exits the treatment tank 218 and is recycled back to the contactor 216. The alkaline solution 220, in the contactor 216, captures more carbon dioxide from air 211.

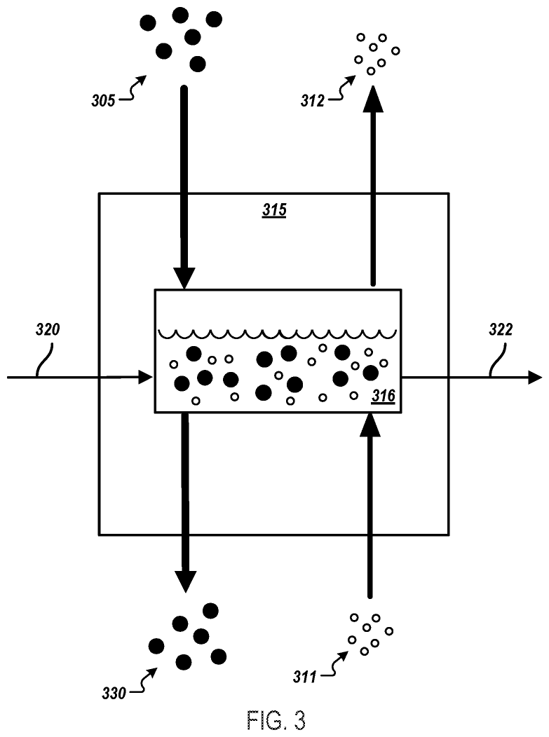

In some implementations, the exposure of the alkaline solution to carbon rich fluid, and the exposure of the RCA particles to the carbonate solution, can occur in the same vessel. An example is shown in FIG. 3, which depicts an exemplary carbonation system 315 including a combined tank 316 to function as both a contactor and treatment tank.

The alkaline solution can be provided to the combined tank 316 through inlet piping 320 and removed from the combined tank 316 through outlet piping 322. The alkaline solution can be provided to the combined tank 316 and removed from the combined tank 316 continuously or in batches. Carbon rich gas 311, such as flue gas, is introduced to the combined tank 316, e.g., using a bubbler. After releasing carbon dioxide to the aqueous alkaline solution, carbon lean gas 312 exits the combined tank 316.

The exposure of the alkaline solution to carbon rich gas 311, and the exposure of the raw RCA particles 305 to the carbonate solution, can occur at different times or simultaneously. In some implementations, the carbon rich gas 311 can be introduced to the alkaline solution in the tank 316 during a first time period, producing the carbonate solution. A batch of raw RCA particles 305 can then be inserted into the combined tank 316 and submerged in the carbonate solution. The batch of raw RCA particles 305 can be soaked in the carbonate solution during a second time period. Enhanced RCA particles 330 can then be removed from the combined tank 316.

In some implementations, gas 211 can be introduced to the alkaline solution in the tank 316 while the RCA particles are soaking in the combined tank 316. For example, the combined tank 316 can contain the alkaline solution and the raw RCA particles 305 while the carbon rich gas 311 is provided to the combined tank 316. The carbon rich gas 311 releases carbon dioxide to the alkaline solution, producing molecules of carbonate solution. The molecules of carbonate solution then release the carbon dioxide to the raw RCA particles 305, producing enhanced RCA particles 330.

In some examples, the enhanced RCA particles 330 exiting the carbonation system undergo additional treatment and processing. For example, the enhanced RCA particles 330 can be rinsed in a rinsing system including rinse tanks. The rinse tanks can be equipped with reverse osmosis systems to recover excess salts and silicates. The excess salts and silicates can be returned to the carbonation system 115.

Referring to FIG. 1, the enhanced RCA particles 330 can be provided to the chemical modification system 116. The chemical modification system 116 can perform silicate fortification soaking to add silicate to the enhanced RCA particles 130. The chemical modification system 116 outputs modified RCA particles 140 that can be used in a concrete mixture.

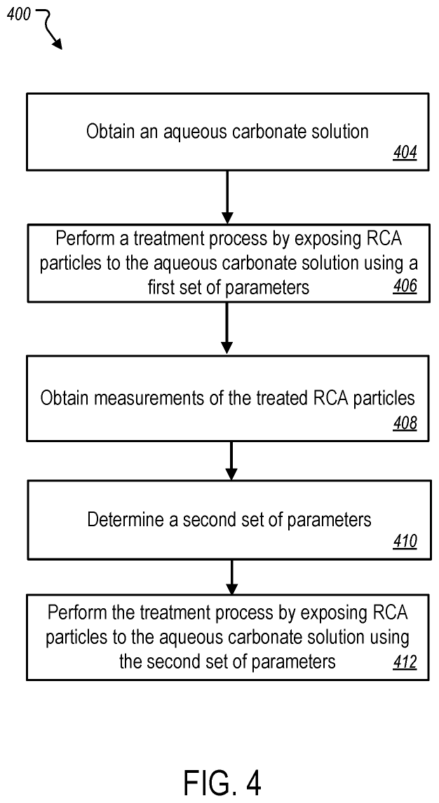

FIG. 4 is a flow diagram that illustrates a process 400 for controlling operation of a recycled concrete treatment system 100. The process 400 can be performed by one or more computing devices. For example, as discussed above, the process 400 may be performed by control system 102 of FIG. 1.

The process 400 includes obtaining an aqueous carbonate solution (404). For example, the aqueous carbonate solution can be obtained by exposing an aqueous alkaline solution to carbon rich ambient air or flue gas.

The process 400 includes performing a treatment process by exposing RCA particles to the aqueous carbonate solution using a first set of parameters (406). For example, a first portion of raw RCA particles can be soaked in the aqueous carbonate solution at conditions specified by a first set of parameters. The conditions can include, for example, a particular time of exposure, volume ratio between raw RCA particles and aqueous carbonate solution, pressure, temperature, size of the raw RCA particles, carbon concentration of the aqueous carbonate solution, pH, conductivity, or any combination of these.

The process 400 includes obtaining measurements of the treated RCA particles (408). For example, the control system can receive data from various sensors 104. Example measurements can include tensile strength, porosity, density, and chemical composition. The control system can analyze the sensor data 122 to characterize the particles. For example, the control system can use image analysis algorithms to detect general shapes and sizes of particles as they are conveyed through a chute or on a conveyor belt. In some implementations, characteristics of the carbonated concrete particles can be compared with target characteristics. If the estimated characteristics differ by a threshold amount from the target characteristics, the control system can determine to adjust parameters and process conditions for the carbonation system.

The process 400 includes determining a second set of parameters (410). For example, the control system can determine a second set of parameters specifying conditions under which a second portion of RCA particles should be exposed to aqueous carbonate solution. The conditions can include, for example, a particular time of exposure, volume ratio between raw RCA particles and aqueous carbonate solution, pressure, temperature, size of the raw RCA particles, carbon concentration of the aqueous carbonate solution, pH, conductivity, or any combination of these. Additional parameters of the RCA treatment process can be adjusted based on the measurements, including parameters of upstream and downstream processes. For example, the control system can adjust parameters such as RCA crushing conditions, RCA treatment recipes, and concrete ingredient recipes.

The process 400 includes performing the treatment process by exposing RCA particles to the aqueous carbonate solution using the second set of parameters (412). For example, a second portion of raw RCA particles can be soaked in an aqueous carbonate solution under conditions specified by the second set of parameters.

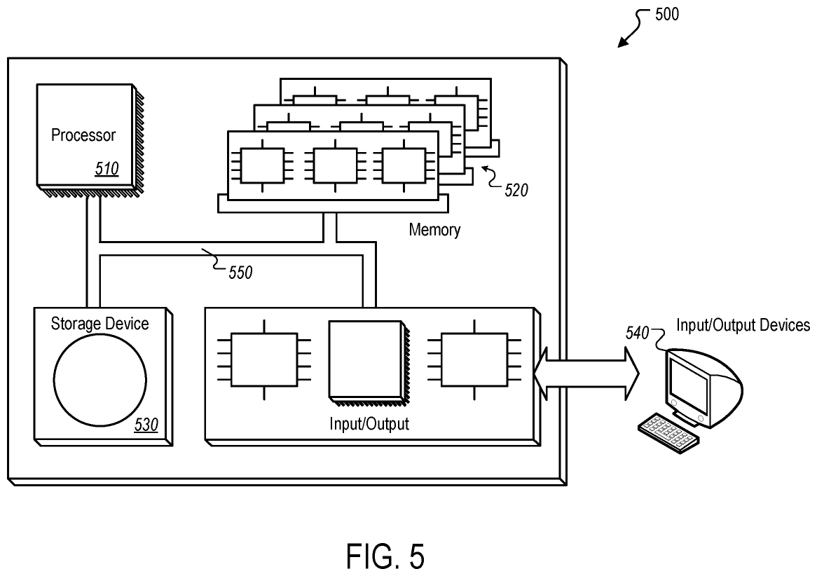

FIG. 5 is a schematic diagram of a computer system 500. The system 500 can be used to carry out the operations described in association with any of the computer-implemented methods described previously, according to some implementations. For example, the system 500 can be the control system 102. In some implementations, computing systems and devices and the functional operations described in this specification can be implemented in digital electronic circuitry, in tangibly-embodied computer software or firmware, in computer hardware, including the structures disclosed in this specification (e.g., system 500) and their structural equivalents, or in combinations of one or more of them. The system 500 is intended to include various forms of digital computers, such as laptops, desktops, workstations, personal digital assistants, servers, blade servers, mainframes, and other appropriate computers, including vehicles installed on base units or pod units of modular vehicles. The system 500 can also include mobile devices, such as personal digital assistants, cellular telephones, smartphones, and other similar computing devices. Additionally, the system can include portable storage media, such as Universal Serial Bus (USB) flash drives. For example, the USB flash drives may store operating systems and other applications. The USB flash drives can include input/output components, such as a wireless transducer or USB connector that may be inserted into a USB port of another computing device.

The system 500 includes a processor 510, a memory 520, a storage device 530, and an input/output device 540. Each of the components 510, 520, 530, and 540 are interconnected using a system bus 550. The processor 510 is capable of processing instructions for execution within the system 500. The processor may be designed using any of a number of architectures. For example, the processor 510 may be a CISC (Complex Instruction Set Computers) processor, a RISC (Reduced Instruction Set Computer) processor, or a MISC (Minimal Instruction Set Computer) processor.

In one implementation, the processor 510 is a single-threaded processor. In another implementation, the processor 510 is a multi-threaded processor. The processor 510 is capable of processing instructions stored in the memory 520 or on the storage device 530 to display graphical information for a user interface on the input/output device 540.

The memory 520 stores information within the system 500. In one implementation, the memory 520 is a computer-readable medium. In one implementation, the memory 520 is a volatile memory unit. In another implementation, the memory 520 is a non-volatile memory unit.

The storage device 530 is capable of providing mass storage for the system 500. In one implementation, the storage device 530 is a computer-readable medium. In various different implementations, the storage device 530 may be a floppy disk device, a hard disk device, an optical disk device, or a tape device.

The input/output device 540 provides input/output operations for the system 500. In one implementation, the input/output device 540 includes a keyboard and/or pointing device. In another implementation, the input/output device 540 includes a display unit for displaying graphical user interfaces.

The features described can be implemented in digital electronic circuitry, or in computer hardware, firmware, software, or in combinations of them. The apparatus can be implemented in a computer program product tangibly embodied in an information carrier, e.g., in a machine-readable storage device for execution by a programmable processor; and method steps can be performed by a programmable processor executing a program of instructions to perform functions of the described implementations by operating on input data and generating output. The described features can be implemented advantageously in one or more computer programs that are executable on a programmable system including at least one programmable processor coupled to receive data and instructions from, and to transmit data and instructions to, a data storage system, at least one input device, and at least one output device. A computer program is a set of instructions that can be used, directly or indirectly, in a computer to perform a certain activity or bring about a certain result. A computer program can be written in any form of programming language, including compiled or interpreted languages, and it can be deployed in any form, including as a stand-alone program or as a module, component, subroutine, or other unit suitable for use in a computing environment.

Suitable processors for the execution of a program of instructions include, by way of example, both general and special purpose microprocessors, and the sole processor or one of multiple processors of any kind of computer. Generally, a processor will receive instructions and data from a read-only memory or a random access memory or both. The essential elements of a computer are a processor for executing instructions and one or more memories for storing instructions and data. Generally, a computer will also include, or be operatively coupled to communicate with, one or more mass storage devices for storing data files; such devices include magnetic disks, such as internal hard disks and removable disks; magneto-optical disks; and optical disks. Storage devices suitable for tangibly embodying computer program instructions and data include all forms of non-volatile memory, including by way of example semiconductor memory devices, such as EPROM, EEPROM, and flash memory devices; magnetic disks such as internal hard disks and removable disks; magneto-optical disks; and CD-ROM and DVD-ROM disks. The processor and the memory can be supplemented by, or incorporated in, ASICs (application-specific integrated circuits).

To provide for interaction with a user, the features can be implemented on a computer having a display device such as a CRT (cathode ray tube) or LCD (liquid crystal display) monitor for displaying information to the user and a keyboard and a pointing device such as a mouse or a trackball by which the user can provide input to the computer. Additionally, such activities can be implemented via touchscreen flat-panel displays and other appropriate mechanisms.

The features can be implemented in a computer system that includes a back-end component, such as a data server, or that includes a middleware component, such as an application server or an Internet server, or that includes a front-end component, such as a client computer having a graphical user interface or an Internet browser, or any combination of them. The components of the system can be connected by any form or medium of digital data communication such as a communication network. Examples of communication networks include a local area network (“LAN”), a wide area network (“WAN”), peer-to-peer networks (having ad-hoc or static members), grid computing infrastructures, and the Internet.

The computer system can include clients and servers. A client and server are generally remote from each other and typically interact through a network, such as the described one. The relationship of client and server arises by virtue of computer programs running on the respective computers and having a client-server relationship to each other.

While this specification contains many specific implementation details, these should not be construed as limitations on the scope of any inventions or of what may be claimed, but rather as descriptions of features specific to particular implementations of particular inventions. Certain features that are described in this specification in the context of separate implementations can also be implemented in combination in a single implementation. Conversely, various features that are described in the context of a single implementation can also be implemented in multiple implementations separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the implementations described above should not be understood as requiring such separation in all implementations, and it should be understood that the described program components and systems can generally be integrated together in a single software product or packaged into multiple software products.

Thus, particular implementations of the subject matter have been described. Other implementations are within the scope of the following claims. In some cases, the actions recited in the claims can be performed in a different order and still achieve desirable results. In addition, the processes depicted in the accompanying figures do not necessarily require the particular order shown, or sequential order, to achieve desirable results. In certain implementations, multitasking and parallel processing may be advantageous.

As used herein, the term “real-time” refers to transmitting or processing data without intentional delay given the processing limitations of a system, the time required to accurately obtain data, and the rate of change of the data. Although there may be some actual delays, the delays are generally imperceptible to a user.

While this specification contains many specific implementation details, these should not be construed as limitations on the scope of what is being claimed, which is defined by the claims themselves, but rather as descriptions of features that may be specific to particular embodiments of particular inventions. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially be claimed as such, one or more features from a claimed combination can in some cases be excised from the combination, and the claim may be directed to a subcombination or variation of a subcombination.

Particular embodiments of the subject matter have been described. Other embodiments are within the scope of the following claims. For example, the actions recited in the claims can be performed in a different order and still achieve desirable results. As one example, the processes depicted in the accompanying figures do not necessarily require the particular order shown, or sequential order, to achieve desirable results. In some cases, multitasking and parallel processing may be advantageous.

What is claimed is:

1. A method of treating recycled concrete aggregate (RCA), the method comprising:
obtaining an aqueous carbonate solution by exposing an aqueous alkaline solution to a carbon dioxide laden fluid;
performing a treatment process on a first portion of RCA particles using a first set of parameters, the treatment process including exposing the first portion of RCA particles to the aqueous carbonate solution;
after performing the treatment process, obtaining measurements of the first portion of RCA particles;
determining, using the measurements of the first portion of RCA particles, a second set of parameters; and
performing the treatment process on a second portion of RCA particles using the second set of parameters.

2. The method of claim 1, wherein exposing the first portion of RCA particles to the aqueous carbonate solution comprises soaking the first portion of RCA particles in the aqueous carbonate solution.

3. The method of claim 1, wherein exposing the aqueous alkaline solution to the carbon dioxide laden fluid comprises introducing ambient air to the aqueous alkaline solution.

4. The method of claim 1, wherein exposing the aqueous alkaline solution to the carbon dioxide laden fluid comprises introducing flue gas to the aqueous alkaline solution.

5. The method of claim 1, wherein obtaining the aqueous carbonate solution by exposing the aqueous alkaline solution to the carbon dioxide laden fluid comprises agitating the aqueous alkaline solution in the presence of the carbon dioxide laden fluid.

6. The method of claim 1, wherein obtaining the aqueous carbonate solution by exposing the aqueous alkaline solution to the carbon dioxide laden fluid comprises introducing bubbles of the carbon dioxide laden fluid into the aqueous alkaline solution.

7. The method of claim 1, wherein the aqueous alkaline solution comprises potassium hydroxide, and the aqueous carbonate solution comprises potassium carbonate.

8. The method of claim 1, comprising:
determining, using the measurements of the first portion of RCA particles, a set of chemical modification parameters; and
performing chemical modification of the first portion of RCA particles using the set of chemical modification parameters.

9. The method of claim 8, wherein performing the chemical modification of the first portion of RCA particles comprises chemically treating the first portion of RCA particles with one or more chemical additives.

10. The method of claim 1, wherein the first set of parameters and the second set of parameters each comprise at least one of:
a pressure at which the treatment process is performed;
a temperature at which the treatment process is performed;
a volume ratio between RCA particles and aqueous carbonate solution;
a pH of the aqueous carbonate solution;
a conductivity of the aqueous carbonate solution; or
a time of exposure of the RCA particles to the aqueous carbonate solution.

11. The method of claim 1, wherein the measurements of the first portion of RCA particles comprise at least one of pH, conductivity, tensile strength, sphericity, size, or porosity.

12. A system for treating recycled concrete aggregate (RCA), comprising:
a contactor configured to facilitate capture of carbon dioxide from a carbon dioxide laden fluid by an aqueous alkaline solution to produce an aqueous carbonate solution;
a treatment tank in fluid communication with the contactor configured to perform a treatment process on RCA particles including exposing the RCA particles to the aqueous carbonate solution;
a plurality of sensors configured to generate sensor data indicating measurements of the RCA particles; and
a control system configured to perform operations comprising:
obtaining sensor data indicating measurements of a first portion of RCA particles after the treatment process is performed on the first portion of RCA particles using a first set of parameters; and
determining, using the sensor data, a second set of parameters for performing the treatment process on a second portion of RCA particles.

13. The system of claim 12, wherein the contactor and the treatment tank are contained within the same vessel.

14. The system of claim 12, wherein the contactor is contained within a first vessel; and the treatment tank is contained within a second vessel.

15. The system of claim 14, comprising a circulation system for transporting the aqueous alkaline solution and the aqueous carbonate solution between the first vessel and the second vessel.

16. The system of claim 12, wherein performing the treatment process comprises soaking the RCA particles in the aqueous carbonate solution.

17. The system of claim 12, wherein the carbon dioxide laden fluid comprises ambient air or flue gas.

18. The system of claim 12, wherein facilitating capture of carbon dioxide from the carbon dioxide laden fluid by the aqueous alkaline solution to produce the aqueous carbonate solution comprises agitating the aqueous alkaline solution in the presence of the carbon dioxide laden fluid.

19. The system of claim 12, wherein facilitating capture of carbon dioxide from the carbon dioxide laden fluid by the aqueous alkaline solution to produce the aqueous carbonate solution comprises introducing bubbles of the carbon dioxide laden fluid into the aqueous alkaline solution.

20. The system of claim 12, wherein the aqueous alkaline solution comprises potassium hydroxide, and the aqueous carbonate solution comprises potassium carbonate.
